(19) United States
(12) Patent Application Publication
(10) Pub. No.: US 2007/0179837 A1
(43) Pub. Date: Aug. 2, 2007

(54) Method of assessing consumer preference tendencies based on a user's own correlated information

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,896

(22) Filed: Jan. 29, 2007

Related U.S. Application Data
(60) Provisional application No. 60/762,514, filed on Jan. 27, 2006.

(51) Int. Cl. G07G 1/00

(52) U.S. Cl. 705/10

(57) ABSTRACT

Assessing consumer preference tendencies is performed by storing a N-dimensional data representation of users' consumer-history data with N>2. The users' consumer-history data relates to items that are associated, at least temporarily, with users. E item is categorizable as a consumer good, a service, or an opinion. First data is received relating to two other items that are selected for purchase by a first user during a current purchase session. Each one of the two other items is also categorizable as a consumer good, a service, or an opinion. A predetermined process is then used to map the first data onto the N-dimensional data representation. This mapped first data is analyzed to correlate the first data with portions of the N-dimensional data representation for identifying items that most highly correlate with the first data. Based on the identified correlation, second data is retrieved from memory relating to an identified item for being suggested to the first user as an additional item to be purchased during the current purchase session. This suggested item is then indicated to the user.

This application claims the benefit of U.S. Provisional Application 60/762,514, filed on Jan. 27, 2006, the entire contents of which are incorporated herein by reference.

### FIELD OF THE INVENTION

The instant invention relates generally to on-line transactions, and more particularly to a method of assessing consumer preference tendencies based on an analysis of a user's own correlated information.

### BACKGROUND

Not so long ago, prior to the explosive growth of the Internet, the advent of on-line shopping, e-commerce and the emergence of “big-box” stores, shopping for items tended to be a quasi-social event. Although mail-order alternatives have existed since the time of the pioneers, and in fact even earlier than this, it has always been common for a consumer to actually enter a retail store and select merchandise for purchase with the assistance of a sales person. Repeat customers at a particular store have always had a great advantage in such a system, since the sales person at that store comes to know the repeat customer over time, as purchases are made and as personal information and other pleasantries are exchanged during the course of doing business. When a relationship has been developed to a sufficient extent, the sales person has the ability to suggest in a highly effective manner items that the repeat customer should consider purchasing, based on the sales person's perception of the repeat customer's preferences and purchase history. Having also a wealth of additional knowledge relating to current trends, popularity of certain combinations of items, etc., the sales person often can simplify the process of shopping and achieve better end results.

More recently, shopping has become a rather anonymous experience. Customers either shop from home via a retailer's commercial web site, or they interact only infrequently with the same sales people when they do actually enter a retail outlet. Accordingly, more often than not today's consumers are forced to make their own decisions regarding which items to purchase. In order to be a “smart consumer,” considerable research must be performed prior to purchasing at least the so-called “big ticket items.” This can be a frustrating, time consuming and ineffective process. Alternatively, consumers may rely upon the recommendations of “global critics” prior to making a purchase. Such critics may offer reviews and recommendations for movies, books, wines, etc., but such recommendations are not personalized for any particular consumer.

According to one prior art technique, which is widely used in e-commerce environments such as for instance an on-line bookstore, additional items are displayed to an on-line consumer based on what the consumer has selected for purchase. Typically, this is done in a one-to-one fashion. That is to say, if the consumer selects a financial book for purchase then a second financial book may be displayed to the consumer, with the hope being that the consumer will purchase the second financial book in addition to the selected one. The retailer may also attempt to up-sell the consumer in this manner. For instance, if the consumer selects a single music CD for purchase, then a two CD compilation set by the same artist, but costing more than the single CD, may be displayed with the hope that the consumer will opt for the higher priced set. This technique provides little added value for the consumer, and is designed primarily to enhance the sales revenue of the retailer.

According to another technique, the on-line retailer provides a survey to be filled out by the consumer. The consumer is expected to provide some types of personal information such as for instance age, gender, marital status, number of children, pets, cars, etc., wage group, and even a list of possessions. From this information, the user may be assigned to a specific demographic group for the purposes of making semi-personalized suggestions and/or providing highly targeted advertising. While the consumer may experience a slightly enhanced shopping experience in exchange for providing personal information about themselves, still it is the retailer that benefits primarily. Furthermore, many consumers are very reluctant to provide any personal information at all, let alone an entire biography, and may even provide deceptively misleading information in an attempt to frustrate the retailer's efforts to target advertising, etc.

It would be advantageous to provide a method for assessing consumer preference tendencies, which overcomes at least some of the above-mentioned limitations of the prior art.

### SUMMARY OF EMBODIMENTS OF THE INSTANT INVENTION

According to an aspect of the instant invention there is provided a method of assessing consumer preference tendencies, comprising: storing a N-dimensional (N>2) data representation of users' consumer-history data, the users' consumer-history data relating to a plurality of items that are associated, at least temporarily, with users, each one of said plurality of items being categorizable as at least one of a consumer good, a service, and an opinion; receiving first data relating to two other items that are selected for purchase by a first user during a current purchase session, each one of the two other items being categorizable as one a consumer good, a service, and an opinion; using a predetermined process, mapping the first data onto the N-dimensional data representation; analyzing the mapped first data to correlate the first data with portions of the N-dimensional data representation, for identifying items of the plurality of items that most highly correlate with the first data; based on the identified correlation, retrieving from memory second data relating to an identified item of the plurality of items for being suggested to the first user as an additional item to be purchased thereby during the current purchase session; and, displaying the second data to the first user.

According to an aspect of the instant invention there is provided a method of assessing consumer preference tendencies, comprising: receiving first data relating to two items that are selected during a current purchase session for being purchased by a first user, each one of the two items being categorizable as one a consumer good, a service, and an opinion; using a predetermined process, mapping the first data onto a N-dimensional (N>2) data structure having stored therein second data relating to a plurality of other items purchased previously by users, each one of said plurality of other items being categorizable as one of a consumer good, a service, and an opinion; analyzing the mapped first data to correlate the first data with portions of the N-dimensional data structure, for identifying items of the plurality of other items that most highly correlate with the selected two items; based on the identified correlation, retrieving from memory third data relating to at least an item of the plurality of other items for being suggested to the first user as at least an additional item to be purchased thereby during the current purchase session; and, displaying the third data to the first user.

According to an aspect of the instant invention there is provided a computer-readable storage medium having stored thereon computer-executable instructions for performing a method of assessing consumer preference tendencies, the method comprising: receiving first data relating to two items that are selected during a current purchase session for being purchased by a first user, each one of the two items being categorizable as one a consumer good, a service, and an opinion; using a predetermined process, mapping the first data onto a N-dimensional (N>2) data structure having stored therein second data relating to a plurality of other items purchased previously by users, each one of said plurality of other items being categorizable as one of a consumer good, a service, and an opinion; analyzing the mapped first data to correlate the first data with portions of the N-dimensional data structure, for identifying items of the plurality of other items that most highly correlate with the selected two items; based on the identified correlation, retrieving from memory third data relating to at least an item of the plurality of other items for being suggested to the first user as at least an additional item to be purchased thereby during the current purchase session; and, displaying the third data to the first user.

### BRIEF DESCRIPTION OF THE DRAWINGS

Exemplary embodiments of the invention will now be described in conjunction with the following drawings, in which similar reference numerals designate similar items:

FIG. 1 is a simplified flow diagram for a method according to an embodiment of the instant invention; and,

FIG. 2 is a simplified flow diagram for a method according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

Methods according to the various embodiments of the instant invention are intended for use with computer systems, such as for instance the Internet of the World Wide Web. The Internet is a widely distributed computer system, including a vast network of computers and file servers that are located in virtually every country on the planet. Although the Internet started out being rather limited in its application, by virtue of relating mainly to highly specialized content of a technical nature and therefore being of interest mainly to the academic and scientific community, today its applications include on-line shopping, financial transactions, virtual diary spaces (web logs or BLOGS), and providing encyclopedic access to information that is of general interest to varied types of individuals and organizations. Furthermore, the continually increasing affordability of computer hardware coupled with improvements in access to high speed residential data transfer systems has resulted in a veritable explosion of use of the Internet over the last several years. The Internet currently enjoys much more widespread appeal, and as a result the individuals that are accessing the Internet now represent a much more demographically diverse group of people.

Although the situation is beginning to change, consumers have been less eager to embrace on-line shopping, choosing instead to make most of their purchases at traditional retail outlets. One reason for this is the risk, whether actual or imagined, relating to on-line fraud and identity theft. Unless the consumer actually is familiar with the on-line retailer, it requires a tremendous amount of faith on the part the consumer to provide personal information, which later could be used either to steal from or to impersonate the consumer. Another reason consumers are reluctant to shop on-line relates to the feeling of being left all alone to make every purchasing decision on their own, without any guidance from a sales person.

According to an embodiment of the instant invention, when an on-line retailer provides an interface for allowing a consumer (hereinafter referred to as a user) to browse merchandise, select parameters relating to the size, quantity, color etc. of the merchandise, and select specific items of merchandise for purchase, a log is kept in which are stored the particulars for each item that is purchased by the user. A similar log is maintained for all users that shop via the interface. Users who are repeat customers, i.e. those who shop more than once or regularly via the interface, are identified during different sessions by at least a user name. Alternatively, a user is identified by a credit card, address or other information. Optionally, the user provides additional personal and/or demographic information, but this is not essential. It is only necessary that the user be identified correctly each time they return to shop via the interface. Of course, user identification by user name is independent of the communication device that is used to access the interface, whether a home computer, laptop, PDA, etc. The log files for all users are retrievably stored in memory, in an N-dimensional data representation, so as to define “users' consumer-history data.” The users' consumer-history data relates to items each user has purchased and optionally items that have been returned or exchanged. Such transactions tend to be indicative of whether a user liked or disliked an item. As stated supra the users' consumer-history data optionally includes other personal and/or demographic information relating to the users, and optionally includes survey or questionnaire results, etc. In this context the term item is not limited simply to physical goods, but also includes services or opinions relating to goods or services, etc.

Clearly, the users' consumer-history data is acquired over some period of time, and may be populated or updated continuously as users purchase additional goods. Since the data relates to the purchase of items only from the retailer that provides the interface, the number of users is large, but not unwieldy. For instance, considering the case of a popular retailer the number of users likely numbers in the tens of thousands or hundreds of thousands, compared to the millions or hundreds of millions for the broader Internet in general. Stored in association with each user is their item purchase history. The data is highly correlated to support comparisons based on groupings of items, rather than comparisons based on single items.

Each time a current user selects a group of at least two items for purchase, and places the those items in a virtual shopping cart, a correlation is performed to match the group of items in the shopping cart with groups of items associated with other users, so as to identify other users having similar groupings of items. The groupings of items associated with the other users optionally were assembled during more than one on-line shopping session. For instance, the other users purchase some of the items during a first shopping session and purchase other of the items during a subsequent second shopping session. Identifying other users having associated therewith groupings of items that are similar to or identical to what is currently in the shopping cart then supports a statistical approach to determine other items, which also are associated with the other users, and which might also be of interest to the current user. The identified other users, those having a similar or identical grouping of items, are referred to for the sake of convenience as the “template users.” Other items associated with the target users are identified. Optionally, additional correlations are performed in substantially the same manner that was described above, except the correlation is to match a sub-set of the other items. The sub-set of other items include items that have not been purchased previously by the current user via the retailer's interface, that are still available for sale and/or in stock, and that optionally relate to or are unrelated to the objects that are currently in the shopping cart.

Additional iterations optionally are performed, in which some of the items in the sub-set of items from a previous iteration are removed and or replaced with a different other item. Removal of some of the other items from the sub-set produces a suggestion space of reduced size and of statistically higher relevance to the current user. Iteration occurs, for instance, until the sub-set contains only other items that are common to every other user or to a predetermined proportion of other users. Optionally, iteration occurs until the suggestion space is reduced to a predetermined number of other items for being suggested to the current user. Optionally, other criteria are used to define the iterative process. Of course, replacing one item with a different item does not reduce the size of the suggestion space, but merely refines the relevancy of the suggestion space. For instance, an item that is associated with only a few of the target users statistically is less likely to be of interest to the current user than an item that is associated with many of the target users.

Of course, if the current user is not a repeat user then there is no available knowledge relating to past purchases the current user has made. In this case, the suggestion space includes items that the user statistically may be interested in, even though there is a chance the current user already owns some of the items.

Optionally, the current user is presented with a display representative of the suggestion space prior to moving to the checkout phase of the session. In this way, the current user has the opportunity to add to or change the contents of the shopping cart while they are still shopping. Further optionally, additional items are suggested as the contents of the shopping cart change through additions or substitutions. Further optionally, the current user is not presented with a display representative of the suggestion space until after advancing to the checkout phase of the session. In this way, the current user is not distracted or bothered while shopping.

The embodiment that is described above provides the user with a virtual sales person to suggest additional items that the user may be interested in, based on the items that the user is currently selecting for purchase. Of course, additional information relating to the current user's past purchases optionally is utilized to improve the accuracy and relevance of the suggestion. For instance, a correlation that is based on two items in the current user's shopping cart, plus in addition the current user's ten most recent purchases, results in data relating to twelve items for being correlated with users' consumer-history data. Other users that have twelve item purchases in common with the current user statistically are more likely also to own other items in which the current user is likely to be interested, compared to other users that have for instance only two or three item purchase in common. Accordingly, as the current user purchases more and more items during subsequent on-line shopping sessions, there is a larger base of data available for correlation, and accuracy is improved.

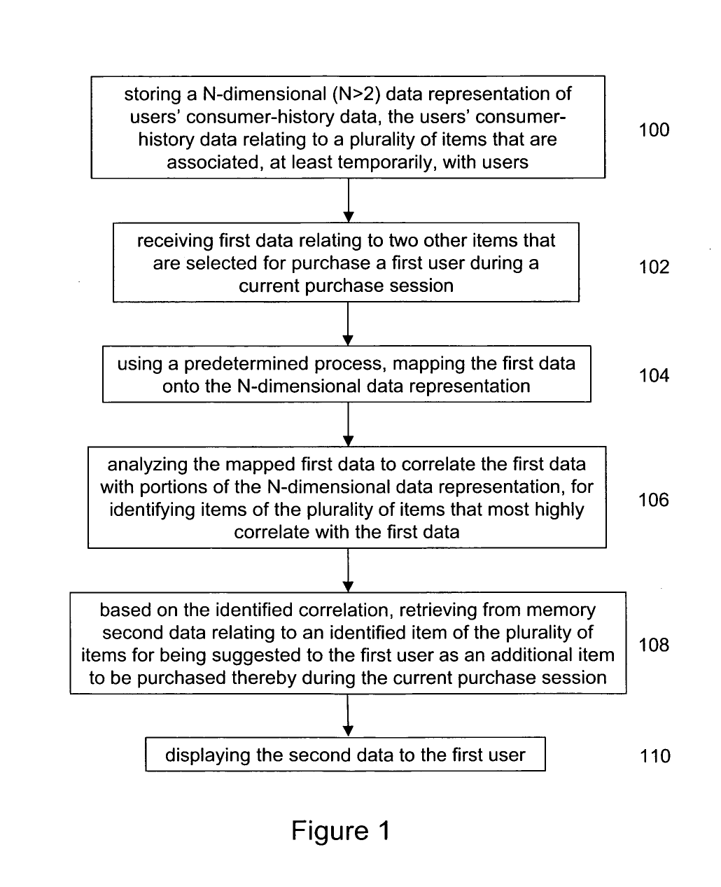

Referring now to FIG. 1, shown is a simplified flow diagram for a method of assessing consumer preference tendencies according to an embodiment of the instant invention. At step 100 a N-dimensional (N>2) data representation of users' consumer-history data is stored. The users' consumer-history data relates to a plurality of items that are associated, at least temporarily, with users. In particular, each one of said plurality of items is categorizable as at least one of a consumer good, a service, and an opinion relating to a consumer good or a service. At step 102 first data is received relating to two other items that are selected for purchase by a first user during a current purchase session, each one of the two other items being categorizable as one of a consumer good, a service, and an opinion relating to a consumer good or a service. At step 104, using a predetermined process, the first data is mapped onto the N-dimensional data representation. At step 106 the mapped first data is analyzed to correlate the first data with portions of the N-dimensional data representation, for identifying items of the plurality of items that most highly correlate with the first data. At step 108, based on the identified correlation, second data relating to an identified item of the plurality of items is retrieving from memory for being suggested to the first user as an additional item to be purchased thereby during the current purchase session. At step 110 the second data is displayed to the first user, for instance the second data is interpreted to produce a two-dimensional or three-dimensional image of the identified item.

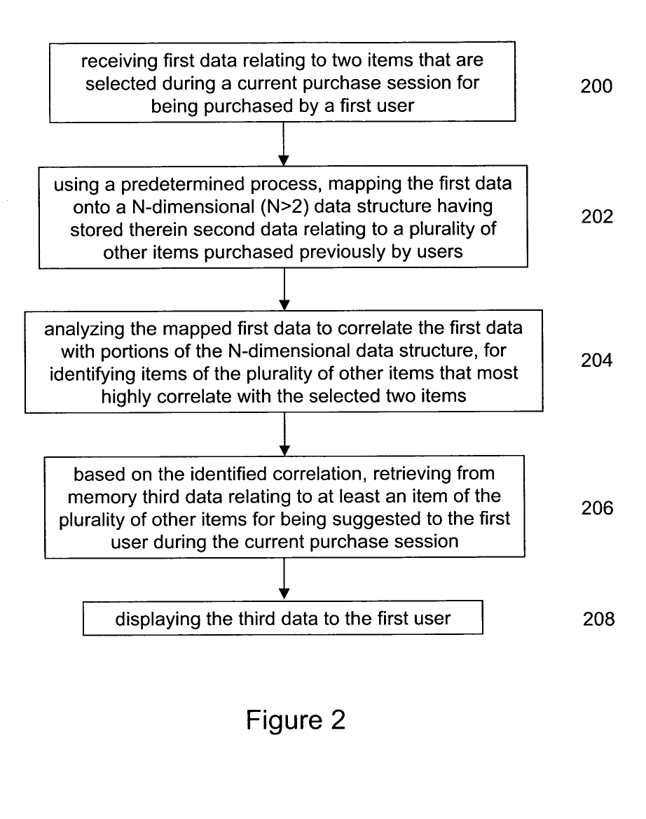

Referring now to FIG. 2, shown is a simplified flow diagram for a method of assessing consumer preference tendencies according to an embodiment of the instant invention. At step 200 first data is received relating to two items that are selected during a current purchase session for being purchased by a first user, each one of the two items being categorizable as one a consumer good, a service, and an opinion relating to a consumer good or a service. At step 202, using a predetermined process, the first data is mapped onto a N-dimensional (N>2) data structure having stored therein second data relating to a plurality of other items purchased previously by users, each one of said plurality of other items being categorizable as one of a consumer good, a service, and an opinion relating to a consumer good or a service. At step 204 the mapped first data is analyzed to correlate the first data with portions of the N-dimensional data structure, for identifying items of the plurality of other items that most highly correlate with the selected two items. At step 206, based on the identified correlation, third data is retrieved from memory, the third data relating to at least an item of the plurality of other items for being suggested to the first user as at least an additional item to be purchased thereby during the current purchase session. At step 208 the third data is displayed to the first user, for instance the third data is interpreted to produce a two-dimensional or three-dimensional image of the at least an identified item.

Numerous other embodiments may be envisioned without departing from the spirit and scope of the invention.

What is claimed is:

1. A method of assessing consumer preference tendencies, comprising:
storing a N-dimensional (N>2) data representation of users' consumer-history data, the users' consumer-history data relating to a plurality of items that are associated, at least temporarily, with users, each one of said plurality of items being categorizable as at least one of a consumer good, a service, and an opinion;
receiving first data relating to two other items that are selected for purchase by a first user during a current purchase session, each one of the two other items being categorizable as one of a consumer good, a service, and an opinion;
using a predetermined process, mapping the first data onto the N-dimensional data representation;
analyzing the mapped first data to correlate the first data with portions of the N-dimensional data representation, for identifying items of the plurality of items that most highly correlate with the first data;
based on the identified correlation, retrieving from memory second data relating to an identified item of the plurality of items for being suggested to the first user as an additional item to be purchased thereby during the current purchase session; and,
indicating the second data to the first user.

2. A method according to claim 1, wherein the consumer history is history of a series of individual purchases of items.

3. A method according to claim 2, wherein purchases from a same purchasing entity are correlated.

4. A method according to claim 1, wherein the first data relates to a current purchase.

5. A method according to claim 1 wherein indicating comprises displaying.

6. A method according to claim 5 wherein the second data comprises data relating to a statistical likelihood that a suggestion is valid.

7. A method according to claim 6 wherein the statistical likelihood is calculated based on the following:
a ratio of a total number of users of users whose data highly correlates who also have the identified item and a total number of users whose data highly correlates.

8. A method according to claim 1 comprising:
determining a statistical likelihood that a suggestion is correct.

9. A method according to claim 8 wherein the statistical likelihood is calculated based on the following:
a ratio of a total number of users of users whose data highly correlates who also have the identified item and a total number of users whose data highly correlates.

10. A method according to claim 9 comprising:
based on the identified correlation, retrieving from memory third data relating to a second identified item of the plurality of items for being suggested to the first user as an additional item to be purchased thereby during the current purchase session; and, wherein the indication is provided of the item and the additional item, the item and the additional item ranked based on the statistical likelihood.

11. A method according to claim 9 wherein the second data relates to a plurality of identified items of the plurality of items for being suggested to the first user as additional items to be purchased thereby during the current purchase session; and, wherein the indication is provided of some of the plurality of items, the some selected based on the statistical likelihood.

12. A method of assessing consumer preference tendencies, comprising:
receiving first data relating to two items that are selected during a current purchase session for being purchased by a first user, each one of the two items being categorizable as one a consumer good, a service, and an opinion;
using a predetermined process, mapping the first data onto a N-dimensional (N>2) data structure having stored therein second data relating to a plurality of other items purchased previously by users, each one of said plurality of other items being categorizable as one of a consumer good, a service, and an opinion;
analyzing the mapped first data to correlate the first data with portions of the N-dimensional data structure, for identifying items of the plurality of other items that most highly correlate with the selected two items;
based on the identified correlation, retrieving from memory third data relating to at least an item of the plurality of other items for being suggested to the first user as at least an additional item to be purchased thereby during the current purchase session; and,
displaying the third data to the first user.

13. A method according to claim 12, wherein the second data relates to a history of a series of individual purchases of items.

14. A method according to claim 13, wherein purchases from a same purchasing entity are correlated.

15. A method according to claim 12, wherein the at least an additional item comprises a plurality of different items, each item of the plurality of different items not currently selected by the first user.

16. A method according to claim 15, wherein displaying the third data to the first user comprises displaying a three-dimensional representation of the third data comprising a plurality of data labels distributed on a surface of a three-dimensional solid shape, each one of the plurality of data labels indicative of one of the plurality of different items not currently selected by the first user.

17. A method according to claim 15 comprising:
determining a statistical likelihood that a different item not selected by a user is a good suggestion.

18. A method according to claim 17 wherein the statistical likelihood is calculated based on the following:
a ratio of a total number of users of users whose data highly correlates who also have the identified item and a total number of users whose data highly correlates.

19. A method according to claim 17 wherein the plurality of different items is ranked based on the statistical likelihood.

20. A computer-readable storage medium having stored thereon computer-executable instructions for performing a method of assessing consumer preference tendencies, the method comprising:
receiving first data relating to two items that are selected during a current purchase session for being purchased by a first user, each one of the two items being categorizable as one a consumer good, a service, and an opinion;
using a predetermined process, mapping the first data onto a N-dimensional (N>2) data structure having stored therein second data relating to a plurality of other items purchased previously by users, each one of said plurality of other items being categorizable as one of a consumer good, a service, and an opinion;
analyzing the mapped first data to correlate the first data with portions of the N-dimensional data structure, for identifying items of the plurality of other items that most highly correlate with the selected two items;
based on the identified correlation, retrieving from memory third data relating to at least an item of the plurality of other items for being suggested to the first user as at least an additional item to be purchased thereby during the current purchase session; and,
displaying the third data to the first user.
